(19) United States
(12) Patent Application Publication
(10) Pub. No.: US 2008/0166074 A1
(43) Pub. Date: Jul. 10, 2008

(54) Alcohol Beverage Bag

(76) Inventors: Ian Anderson, Cambridge (GB); Stephen J. Grimwade, Cambs (GB)

Correspondence Address: James W. Kerr;InBev S.A., 303 Richmond Street, London, ON, N6B2H8, omitted

(21) Appl. No.: 10/576,822

(22) PCT Filed: Oct. 22, 2004
(86) PCT No.: PCT/IB2004/003477

§ 371 Date: Aug. 23, 2007

(30) Foreign Application Priority Data
Oct. 24, 2003 (GB) 0324907.5

(51) Int. Cl. B67D 5/60

(52) U.S. Cl. 383/42

(57) ABSTRACT

A bag suitable for containing an alcohol beverage has two panels (14,16) having adjacently positioned edges forming at least one seam. The seam has a joined seam portion where the adjacently positioned edges (20,22,30,32) of the panels are joined together. The seam also has an open seam portion (24) where the adjacently positioned edges of the panels are not joined together. A bag neck molding (40) extends through the open seam portion of the panels. The bag neck molding is secured in sealing relation with the panels of the bag at the open seam portion. The bag neck molding has at least one valve (47,48) accessible for operation from outside the bag and supporting a spear (50) extending into the bag through which the beverage may pass.

### FIELD OF THE INVENTION

The present invention relates to an alcohol beverage containing bag, and in particular, to the mounting of the bag mold neck in the bag body.

### BACKGROUND OF THE INVENTION

It is known to construct an alcohol bag in a manner that when the bag is filled with an alcohol beverage, such as, for example, beer or wine, the bag resembles the shape of the container in which the bag is housed.

In applications where the bag is used to contain beer, the bags are typically housed in a keg having a generally cylindrical shape. The bag has a neck portion secured to the keg. The bag is deflated, past through a keg aperture and then filled with beer. After the beer is dispensed from the keg, the bag is removed through the aperture. Typically, the bag comprises two circular panels spaced apart by a cylinder sheet. The sheet is welded at its ends to the circular panels to form two end seams. The sheet is also welded along its length to form a third seam. An aperture is cut into one of the circular sheets to receive a similarly shaped bag neck molding. The bag neck mold is sealed to the aperture cut into the circular panel of the bag so as to form a forth seam. With every seam that is created, there is a potential for bag rupture or weakening along that seam. Any reduction in the number of seams utilized in the bag manufacture reduces the complexity of the bag manufacture and should improve the reliability of the bag.

### SUMMARY OF THE INVENTION

The present invention contemplates a bag suitable for containing an alcohol beverage that does not require the creation of an additional seam for securing the bag neck molding with the bag body.

The present invention relates to a bag suitable for containing an alcohol beverage, preferably beer, in a container, preferably a keg. The bag has at least two panels having adjacently positioned edges forming at least one seam. The seam has a joined seamed portion where adjacently positioned edges of the panels are joined together. The seam further has an open seam portion where adjacently positioned edges of the panels are not joined together. The present invention advantageously provides a bag neck molding that extends through the open seam portion to make use of an existing seam in the bag without having to create an additional seam to accommodate the bag neck molding. The bag neck molding is secured in sealing relation with the panels of the bag at the open seam portion to close the bag.

Preferably, the bag neck molding is joined to the adjacently positioned edges of the panels extending along the open bag portion. It is contemplated that the joining of the panels to the bag neck molding may be accomplished either by welding or by the use of an adhesive.

Additionally, the adjacently positioned edges of the open seam portion may have a reinforcing edge wall portion extending there along. This reinforcing edge wall portion comprises a layer of thicker material than at the edges used in the major seam portion where the seams are already joined. This additional thickness in material acts as a reinforcement during the insertion of the bag neck molding into the open seam so as to reduce the risk of splitting open the closed seam portion.

The bag neck molding preferably has a peripheral side wall that has a circumference greater in length than the accumulative length of the adjacently positioned edges of the panels extending along the open seam.

It is further contemplated that the shape of the bag neck molding may be chosen to be readily inserted into the open seam portion without causing damage to the bag. Accordingly, the bag neck molding may have a shape that is elongated corresponding to the elongation of the open seam portion. The bag neck molding may have two rounded end corners and two opposing gently convexly curved side portions that extend between the rounded end portions of the bag neck molding.

In accordance with one aspect of the present invention there is provided a bag suitable for containing an alcohol beverage. The bag comprises at least two panels having adjacently positioned edges forming at least one seam. The seam has a joined seam portion where the adjacently positioned edges of the panels are joined together. The seam also has an open seam portion where the adjacently positioned edges of the panels are not joined together. A bag neck molding extends through the open seam portion. The bag neck molding is secured in sealingly relation with the panels of the bag at the open seam portion. The bag neck molding supports a valve accessible for operation from outside the bag and also supports a spear extending into the bag through which the beverage may pass.

### BRIEF DESCRIPTION OF THE DRAWINGS

For a better understanding of the nature and objects of the present invention reference may be had to the accompanying diagrammatic drawings in which:

FIG. 1 is a perspective view of showing a pre-assembly stage for the bag of the present invention; and

FIG. 2 is a partial perspective view of the bag of the present invention.

### DETAILED DESCRIPTION OF THE INVENTION

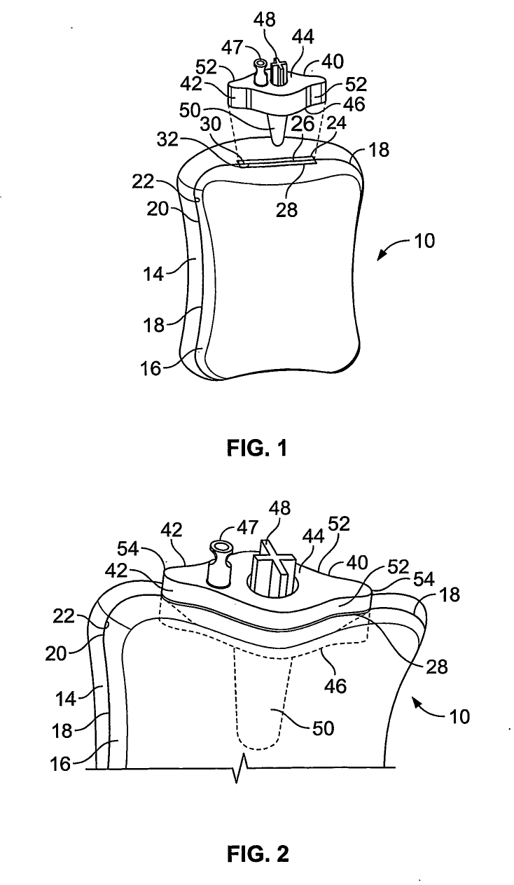

Referring to FIGS. 1 and 2 there is shown a bag 10 having a preferred construction for use in a container. The bag 10 is suitable for use for housing an alcohol beverage and in the preferred embodiment for housing beer. The bag 10 is pliable and preferably comprises two panels of plastic material 14 and 16 which are joined together along adjacently positioned edges 20 and 22 respectively to form a joined seam portion 18. It should be understood that each panel 14, 16 may comprise one or more layers of plastic material joined along an edge and that these layers of material may not necessarily be laminated together.

As best seen in FIG. 1, the two panels 14 and 16 also have an open seam portion 24. The open seam portion 24 comprises reinforcing edge wall portions 26 and 28 which comprise a thicker material than the corresponding edges 20 and 22 of the panels 14 and 16. The reinforcing edge wall portions 26 and 28 form their own adjacently positioned edges 30 and 32 respectively. It should be understood that the seam at the open seam portion 24 is not joined together along the adjacently positioned edges 30 and 32 of panels 14 and 16.

The bag of the present invention further includes a bag neck molding 40. The bag neck molding 40 provides one or more controlled access ports to facilitate the filling and dispensing of beverage into and out from the bag 10. The bag neck molding 40 is able to be mounted relative to a container (not shown) so as to support the bag 10 within the container. The bag neck molding 40 has a continuous side wall 42 and a top wall 44 and bottom wall 46. The bag neck molding comprises a sturdier plastic material than the panels 14, 16 and has two valves 47, 48 as shown in the preferred embodiment. Valve 47 is utilized for allowing gases to pass into and out of the bag 10 during filling and dispensing of beverage from the bag 10. Valve 48 is utilized to permit beverage to be filled into the bag 10 and also to be removed from the bag 10.

The bag neck molding 40 is further provided with a spear 50. Spear 50 is adapted to extend into the interior of the bag 10 so as to permit for the insertion and removal of beverage from the bag 10. Preferably, the spear 50 extends downwardly adjacent the bottom of the bag 10 so as to be able to extract beverage from the bottom of the bag 10. Clearly, the length of the spear 50 and shape may be longer than that shown in the drawings and of course its shape shown here is for illustrative purposes only.

The bag neck molding 40 has an elongated shape where the side walls 42 comprise two opposing gently convexly curved side portions 52 and two rounded end corner portions 54. The circumference around the side wall 42 is larger than the circumference defined by the open seam portion 24 along both confronting adjacently positioned edges 30 and 32. As a result, as the neck molding 40 is inserted into the open seam 24, the edges 30 and 32 of the panels 14 and 16 are opened and the reinforcing walls 30 and 32 engage the side wall 42 of the bag neck molding 40 (see FIG. 2). The thickened walls 28 and 30 engage the side wall 42 and are secured in sealing relation thereto either by means of an adhesive or by additional welding of the reinforced side walls 28 and 30 to the side wall 42 of the bag neck molding 40. It should be understood that this attachment may not necessarily simply involve the edges 30, 32 of the panels 14, 16 but may involve some other panel portion that may be adhered or joined to the side wall 42 of the bag neck molding 40.

What is claimed is:

1. A bag suitable for containing an alcohol beverage comprising:
at least two panels having adjacently positioned edges forming at least one seam, the seam having a joined seam portion where the adjacently positioned edges of the panels are joined together, and an open seam portion where the adjacently positioned edges of the panels are not joined together; and,
a bag neck molding extending through the open seam portion, the bag neck molding being secured in sealing relation with the panels of the bag at the open seam portion, and the bag neck molding supporting a valve accessible for operation from outside the bag and supporting a spear extending into the bag through which the beverage may pass.

2. The bag of claim 1 wherein the bag neck molding is joined to the adjacently positioned edges of the panels extending along the open seam portion.

3. The bag of claim 1 wherein the adjacently positioned edges of the open seam portion have a reinforcing edge wall portion.

4. The bag of claim 3 wherein the reinforcing edge wall portion comprises a layer of material thicker than the adjacently positioned edges extending along the major seam portion.

5. The bag of claim 1 wherein the bag neck molding has a peripheral side wall having a circumference greater in length than the adjacently positioned edges of the panels extending along the open seam.

6. The bag of claim 1 wherein the bag neck molding has an elongated shape with two rounded end corner portions and two opposing gently convexly curved side portions extending between the rounded end portions.

7. The bag of claim 1 wherein the bag neck mold is secured in sealing relation with the panels of the bag open seam portion by an adhesive.

8. The bag of claim 1 wherein the bag neck mold is secured in sealing relation with the panels of the bag open seam portion by a weld.

9. The bag of claim 4 wherein the bag neck mold is secured in sealing relation with the panels of the bag open seam portion by an adhesive.

10. The bag of claim 4 wherein the bag neck mold is secured in sealing relation with the panels of the bag open seam portion by a weld.
